(19) United States
(12) Patent Application Publication
(10) Pub. No.: US 2022/0235602 A1
(43) Pub. Date: Jul. 28, 2022

(54) UNIDIRECTIONALLY SWINGING LINKAGE SHUTTER, LINKAGE SHUTTER SKYLIGHT ROOF, AND SHUTTER BLADES

(71) Applicant: Dongzuo YANG, Dongguan (CN)

(72) Inventor: Dongzuo YANG, Dongguan (CN)

(21) Appl. No.: 17/606,615

(22) PCT Filed: Apr. 1, 2020
(86) PCT No.: PCT/CN2020/082834

§ 371 Date: Oct. 26, 2021

(30) Foreign Application Priority Data
May 16, 2019 (CN) 201910407121.0

(51) Int. Cl. E06B 7/098; E04B 7/16; E06B 7/14

(52) U.S. Cl. CPC E06B 7/098; E06B 7/14; E04B 7/163

(57) ABSTRACT

The invention discloses an unidirectionally swinging linkage shutter, a roof with the shutter and a louver blade. The shutter includes a frame and a louver blade, the frame includes a longitudinal keel, the longitudinal keel includes longitudinal keel body and a positioning bar, a pin hole is defined on the positioning bar and beyond the wall, one end of the louver blade close to the indoor is hinged on the pin hole via a pin shaft, the louver blade includes a protruding section protruding outward, a linkage connection position is defined on the protruding section. The roof with the shutter includes a transverse roof beam, a longitudinal roof beam and a louver blade, the longitudinal keel includes a longitudinal keel body and a positioning bar, the positioning bar is provided with a pin hole. The structure of the louver blade is the same as above. In the present invention, the linkage bar will not interfere after the louver blades are closed, and the sealing performance is good, and the water and wind shielding effects of the louver blades are good; it is convenient to install and disassemble the louver blades on site, and can avoid the arbitrary removal of the louver blades from the outside.

### CROSS REFERENCE TO PRIORITY APPLICATIONS

The present application is the US National stage application from the PCT application PCT/CN2020/082834 filed on Apr. 1, 2020, which claims priority of Chinese patent application No.201910407121.0, filed on May 16, 2019 at the China National Intellectual Property Administration, CNIPA. The disclosures of the above applications are incorporated herein by reference.

### FIELD OF THE INVENTION

The present invention relates to a louver blade, an unidirectionally swinging linkage shutter and a roof with the linkage shutter.

### BACKGROUND OF THE INVENTION

Shutters are one of the styles of windows, which originated in China. A typical application in ancient Chinese architecture is mullion windows, which are used in all dynasties from the Warring States to the Han Dynasty. The windows with vertical bars are often called mullion windows, and those with horizontal bars are called lattice windows. Lattice window is one style of shutters, in other words it is the original design of shutters.

Most of the existing shutters are hidden in the frame, of course there are also swing-out ones. For example, a kind of shutters is disclosed in Korean patent KR1020180119543. The louver blades of the shutter are swing-out, the middle of the louver blades of the structure is hinged on the frame, and a linkage rod is hinged on the end faces of the louver blades. In this case, it is necessary to give the linkage rod an avoidance space on the inner side of the frame, otherwise the linkage rod will interfere with the frame, resulting in poor sealing performance after the louver blades are closed; in addition, in this structure, the louver blade is flat, so that, when the louver blades are opened, rainwater can easily enter the room from the shutters.

Another shutter is disclosed in the US patent US20010037604A1. The structure of the shutter is basically the same as KR1020180119543, and it also has the same defects.

In the U.S. Pat. No. 10,184,685B1, a shutter is disclosed. The louver blades of the shutter are hinged on the frame via a pin shaft, and the frame is used to prevent the pin shaft from detaching. But the frame is installed in the wall. Although one end of the louver blade is hinged on the frame, the hinge position of the louver blade is located in the wall. Therefore, this structure is very inconvenient to install the pin shaft and louver blades, and the subsequent maintenance is inconvenient, the drainage of rainwater is not smooth, and the rainwater easily enters the room.

Another shutter is disclosed in Korean patent KR101196850B1. In this patent, it is easy to replace only the shutters to be replaced in the installed shutter system, and it is not necessary to replace the entire shutter system to replace the shutters. The shutter includes a frame and a louver, the louver is slidably inserted between the frames, and the louver is made of colored glass. Although this patent discloses transparent shutters, it is inconvenient to install and disassemble the glass, and rainwater dripping on the shutters is difficult to drain.

However, the above technical solution has the following problems:

Therefore, there is a need to invent a new equipment to solve the above-mentioned problems.

### SUMMARY OF THE INVENTION

The first object of the invention is to provide an unidirectionally swinging linkage shutter, the shutter in the present invention has the following advantages: the linkage bar will not interfere with the frame after the louver blades are closed, and the sealing performance is good, and the water and wind shielding effects of the louver blades are good; it is convenient to install and disassemble the louver blades on site, and can avoid the arbitrary removal of the louver blades from the outside.

The second object of the invention is to provide a roof with the linkage shutter, the roof has the following advantages: the linkage bar will not interfere with the longitudinal roof beam after the louver blades are closed, and the sealing performance is good, and the water and wind shielding effects of the louver blades are good; it is convenient to install and disassemble the louver blades on site, and can avoid the arbitrary removal of the louver blades from the outside.

The third object of the invention is to provide a louver blade, the louver blade has the following advantages: the sealing performance is good after the louver blades are closed, the water and wind shielding effects of the louver blades are good.

In accordance with an aspect of the embodiment, there is provided a unidirectionally swinging linkage shutter, comprising: a frame and a louver blade; the frame includes a transverse keel and a longitudinal keel; wherein, the longitudinal keel includes a longitudinal keel body and a positioning bar, the positioning bar protrudes from the longitudinal keel body towards an outdoor side, the positioning bar is provided with the same number of pin holes as the louver blades, the pin hole is located beyond the outdoor side of a wall used to install the longitudinal keel body; the louver blade includes a blade body, the length of the blade body is greater than the distance between the inner sides of the two longitudinal keel bodies, the blade body is provided with a swing shaft end and an outer swing end, the swing shaft end is located at one end of the blade body, the outer swing end is located at the other end of the blade body, a pin accommodating hole is provided at the swing shaft end, the outer swing end is provided with a protruding section protruding to the outer side of the wall, a linkage connection position is defined on the protruding section; when the louver blade is closed, all the linkage connection positions are farther away from the outer side of the wall than all the pin accommodating holes; the louver blade is hinged to the positioning bar via a pin shaft passing through the pin hole and the pin accommodating hole, on the linkage connection position of all the louver blades in the same longitudinal direction is provided with a linkage bar, the linkage bar is located on the outdoor side, and the linkage connecting bar is farther away from the outdoor side than the pin hole; a protective strip is fixed on the longitudinal keel to block the pin shaft on the outdoor side.

In the present invention, the louver blade is provided with the protruding section, the protruding section are defined protrudingly, and the linkage connecting position for connecting the linkage bar is arranged on the protruding section, the linkage connecting position is farther away from the wall compared with the pin accommodating hole. Compared with the prior art, there is no necessary to provide an avoidance position on the frame for installing the louver blade, that is, it can have good sealing performance after the louver blade is closed without interference. Due to the protruding section, when louver blades are opened, the protruding section can effectively reduce the entry of wind and rain into the room. For the swing-out shutter, the mounting holes for installing the louver blades are located beyond the outside of the wall, so that the louver blades can be installed and removed outdoors. Of course, the pin shaft is defined outdoors. In this case, the protective strip is provided for better anti-theft. In the above structure, the louver blades are located outside the wall. Therefore, after the louver blades are opened, even if the rainwater leaks from the inner end of the louver blades, the rainwater will be discharged from the outside and will not enter the room, so that the discharge performance of the whole shutter is very good.

Furtherly, a drainage groove is arranged on the longitudinal keel body on the side of the positioning bar close to the louver blade, and a drainage groove is located on the outdoor side of the wall for installing the longitudinal keel body. Due to the drainage grooves, most of the rain and wind from the outside to the shutters will be guided to two sides via the louver blades and enter the drainage grooves, and there is no protective strip installed on the horizontal keel at the lower end, so that the rainwater will be better discharged from the drainage groove to the outdoors, and the wind flow can reduce the noise such as “whistle” at the louver blades.

Furtherly, the longitudinal keel body includes a keel beam, a ridge and a stiffened plate, the ridge protrudes from the outside of the keel beam, the stiffened plate protrudes from the keel beam to the outdoor side and is located on the side close to the louver blade, the positioning bar is connected on the ridge, the drainage groove is formed between the ridge and the stiffened plate. In practical applications, the louver blade used is an outer unidirectionally swinging type, the louver blade is hinged on the outer side of the frame, so that when the longitudinal keel is formed, the positioning bar for installing the louver blade is provided on the outer side of the longitudinal keel, and the pin hole is provided on the positioning bar. The process is to first form the longitudinal keel, and then process the pin hole. Due to the longitudinal keel with the above structure, the positioning bar is movably connected to the longitudinal keel body, the pin hole can be machined on the positioning bar and then installed on the longitudinal keel body, reducing the processing cost and difficulty.

Furtherly, a sealing strip groove is longitudinally extended at the outside of the stiffened plate, and the sealing strip groove is clamped with a longitudinal sealing strip which is in contact with the louver blade. When the louver blade is closed, under the action of the longitudinal sealing strip, the sealing performance of the louver blade and the longitudinal keel is good to prevent rain and wind from entering the room.

Furtherly, a locking groove is provided at the outdoor side end of the ridge, one end of the positioning bar is clamped in the locking grove, the other end of the positioning bar faces the outdoor side, a positioning bar fastener is provided between the positioning bar and the ridge. In this way, it is convenient to install the positioning bar, and the fixing of the positioning bar is reliable and the fixing is firm.

Furtherly, the cross section of the protective strip includes a fixed portion, a conceding portion connected to the fixed portion, and a clamping portion connected to the conceding portion, the fixed portion and the longitudinal keel body are connected by a fastener, a conceding space is formed between the conceding portion and the protective strip, the clamping portion is clamped on the protective strip. The fixed portion is convenient to connect the positioning bar to the horizontal keel or the longitudinal keel. The conceding space is used to reserve space for the pin shaft. At the same time, the conceding portion is used to resist the pin shaft to avoid interference and detachment. The clamping portion is used for clamping the positioning bar, thus, the installation and positioning of the protective strip are reliable.

Furtherly, the fixed portion is positioned on the side wall of the longitudinal keel body by a fastener passing from the wall to the direction of the louver blade, the outdoor side of the wall has a resisting portion, the resisting portion abuts against the frame, and the resisting portion blocks the fastener. When fixing the protective strip, the operator can install the fasteners from indoors to outdoors, but indoor installation will cause the fixed portion to be exposed, which affects the aesthetics. If the fastener is installed from the outside, it is easy to install, but it is easy to remove the protective strip from the outside. In this way, the protective strip cannot serve the purpose of hiding and limiting the pin shaft. For this reason, the resisting portion of the wall is allowed to cover the fasteners to solve the problem of easy disassembly.

Furtherly, the protective strip is provided with a first blocking portion located on the outdoor side of the drainage groove, the longitudinal keel body is provided with a second blocking portion located on the outdoor side of the drainage groove on the side of the drainage groove close to the louver blade, the first blocking portion and the second blocking portion are staggered in the outdoor side direction. Since the first blocking portion and the second blocking portion are provided, in this way, it is possible to effectively prevent sundries and the like from entering the drainage groove and jamming the drainage groove. After the louver blades are installed, the first blocking portion is basically located outside the closed louver blades, so that the water and wind on the louver blades will be better guided into the drainage groove.

Furtherly, an anti-mosquito net keel is installed on an indoor side of the frame, the cross section of the anti-mosquito net keel includes an inserting portion, an anti-mosquito net blocking portion, and an anti-mosquito net fixed portion; a positioning slot is provided on the frame, and a positioning protrusion locked into the positioning slot is provided on the insertion portion; the anti-mosquito net blocking portion is connected to the indoor side of the inserting portion, the anti-mosquito net blocking portion leans against on the frame, and the anti-mosquito net fixed portion is connected to the inserting portion or the anti-mosquito net blocking portion. After the mosquito net is fixed with the anti-mosquito net fixed portion, the inserting portion is inserted into the frame, and the positioning protrusion is clamped into the positioning slot, the anti-mosquito net blocking portion resists against the frame, then they are installed in place and can effectively prevent the mosquito net keel from separating from the frame.

Furtherly, the cross section of the protruding section includes a first connecting portion, a transition portion and a second portion, the first connecting portion extends from the outer end of the blade body and extends to the outer side of the blade body, and the transition portion is connected to the outer end of the first connecting portion, the second connecting portion is connected to the transition portion and extends toward the inner surface of the blade body. When the louver blades are opened, the first connecting portion has a guiding effect on rain and wind, and guides rain or wind to the outer surface of the blade body, meanwhile, an included angle is formed between the second connecting portion and a vertical line to guide rain and wind to the outside, so as to more effectively prevent rain and wind from entering the room.

Furtherly, a sealing structure is provided at the other end of the blade body; the sealing structure includes a sealing strip fixing portion and a matching portion connected to the outer end of the sealing strip fixing portion; the cross section of the mating portion is in the shape of a circular arc with a middle portion protruding to the outdoor side; the cross section of the sealing strip fixing portion is two limiting plates, and the two limiting plates extend outward from the outer end of the blade body, a sealing strip clamping groove is formed between the two limiting plates. The sealing strip fixing part is used to fix the sealing strip, and the function of the matching portion is to make the arc-shaped matching portion fit with the outer wall of the end of the swing shaft end after the louver blade is closed. The sealing performance between adjacent louver blades is further improved, and the sealing strip can be easily clamped and fixed through the sealing strip clamping groove.

Furtherly, a baffle is provided on the outer surface of the blade body close to the swing shaft end, and the baffle extends toward the outer side of the blade body. When the louver blades are opened, rain and wind will be blocked, reducing the possibility of rain or wind from entering the room.

Furtherly, the blade body includes two blade plates, a transverse slot is formed between the two blade plates, a window communicating with the transverse slot is provided on the blade plate, and a transparent plate is inserted into the transverse slot. Due to the transverse slot, it is convenient to install and remove the transparent plate. Due to the transparent plate, the indoor brightness is improved when the louver blades are opened or closed.

Furtherly, a switch device is provided between at least one louver blade and the frame; the switch device includes a driving wheel and a driving rod; the driving wheel is fixed on the louver blade, the rotation center of the driving wheel is coaxial with the center of the pin accommodating hole, and the driving wheel is a worm gear; the driving rod passes through the frame, and the driving rod is a worm, which is engaged with the worm gear. The switch device has a simple structure and is reliably driven.

Furtherly, the linkage connection position is a hinge hole, a waist-shaped hole is provided on the linkage bar corresponding to the hinged hole, and a pin passes through the hinged hole and the waist-shaped hole. Due to the errors in the processing of the louver blade and the linkage bar, the louver blade has a certain error after installation. When the waist-shaped hole is adopted, the waist-shaped hole is located in a certain adjustment space of the pin, thus, the connection between the linkage bar and the louver blade is convenient, and there is no need to consider the errors of each component.

In accordance with another aspect of the embodiment, there is provided a roof with the linkage shutter, comprising: a transverse roof beam and a longitudinal roof beam, the longitudinal roof beam is arranged on the transverse roof beam; there are more than two longitudinal roof beams; wherein, a louver blade is arranged between adjacent longitudinal roof beams; the longitudinal roof beam includes a longitudinal keel, the longitudinal keel includes a longitudinal keel body and a positioning bar, the positioning bar protrudes from the longitudinal keel body towards an outdoor side, the positioning bar is provided with the same number of pin holes as the louver blades, the louver blade includes a blade body, the length of the blade body is greater than the distance between the inner sides of two longitudinal keel bodies, the blade body is provided with a swing shaft end and an outer swing end, the swing shaft end is located at one end of the blade body, the outer swing end is located at the other end of the blade body, a pin accommodating hole is provided at the swing shaft end, the outer swing end is provided with a protruding section protruding to the outer side of the wall, a linkage connection position is defined on the protruding section; when the louver blade is closed, all the linkage connection positions are farther away from the outer side of the longitudinal roof beam than all the pin accommodating holes; the louver blade is hinged to the positioning bar via a pin shaft passing through the pin hole and the pin accommodating hole, on the linkage connection position of all the louver blades in the same longitudinal direction is provided with a linkage bar, the linkage bar is located on the outdoor side, and the linkage connecting bar is farther away from the outdoor side than the pin hole; a protective strip is fixed on the longitudinal keel to block the pin shaft on the outdoor side.

Furtherly, the louver blade in the present invention is provided with the protruding section, the protruding section are defined protrudingly, and the linkage connecting position for connecting the linkage bar is arranged on the protruding section, the linkage connecting position is farther away from the longitudinal roof beam compared with the pin accommodating hole when the louver blades are closed. There is no necessary to provide an avoidance position on the longitudinal roof beam for installing the louver blade, that is, it can have good sealing performance after the louver blade is closed without interference.

Due to the protruding section, when louver blades are opened, the protruding section can effectively reduce the entry of wind and rain into the room. For the roof with the linkage shutter, the mounting holes for installing the louver blades are located beyond the outside of the wall, so that the louver blades can be installed and removed outdoors. Of course, the pin shaft is defined outdoors. In this case, the protective strip is provided for better anti-theft. In the above structure, the louver blades are located above the main structure of the roof. Therefore, after the louver blades are opened, even if the rainwater leaks from the inner end of the louver blades, the rainwater will be discharged from the outside and will not enter the room, so that the discharge performance of the whole shutter is very good.

Furtherly, the longitudinal roof beam includes a longitudinal roof beam body, two positioning plates extend upward from both sides of the longitudinal roof beam body, an accommodating slot is defined between the two positioning plates; the longitudinal keel body is provided with a positioning portion, the longitudinal keel body is received in the accommodating slot, the positioning portion is connected with the positioning plate. In this way, it is convenient to process the longitudinal roof beam.

Furtherly, a drainage groove is arranged on the longitudinal keel body on the side of the positioning bar close to the louver blade. Due to the drainage grooves, most of the rain and wind from the outside to the roof will be guided to two sides via the louver blades and enter the drainage grooves, the drainage groove is located on the outside, so that the rainwater will be better discharged from the drainage groove to the outdoors, and the wind flow can reduce the noise such as “whistle” at the louver blades.

Furtherly, the longitudinal keel body includes a keel beam, a ridge and a stiffened plate, the ridge protrudes from the outside of the keel beam, the stiffened plate protrudes from the keel beam to the outdoor side and is located on the side close to the louver blade, the positioning bar is connected on the ridge, the drainage groove is formed between the ridge and the stiffened plate. In practical applications, the louver blade used is an outer unidirectionally swinging type, the louver blade is hinged on the outer side of the longitudinal roof beam, so that when the longitudinal roof beam is formed, the positioning bar for installing the louver blade is provided on the outer side of the longitudinal keel, and the pin hole is provided on the positioning bar. The process is to first form the longitudinal keel, and then process the pin hole. Due to the longitudinal keel body and the positioning bar with the above structure, the positioning bar is movably connected to the longitudinal keel body, the pin hole can be machined on the positioning bar and then installed on the longitudinal keel body, reducing the processing cost and difficulty.

Furtherly, a sealing strip groove is longitudinally extended at the outside of the stiffened plate, and the sealing strip groove is clamped with a longitudinal sealing strip which is in contact with the louver blade. When the louver blade is closed, under the action of the longitudinal sealing strip, the sealing performance of the louver blade and the longitudinal keel is good to prevent rain and wind from entering the room.

Furtherly, a locking groove is provided at the outside end of the ridge, one end of the positioning bar is clamped in the locking grove, the other end of the positioning bar faces the outer side, a positioning bar fastener is provided between the positioning bar and the ridge. In this way, it is convenient to install the positioning bar, and the fixing of the positioning bar is reliable and the fixing is firm.

Furtherly, the cross section of the protective strip includes a fixed portion, a conceding portion connected to the fixed portion, and a clamping portion connected to the conceding portion, the fixed portion and the longitudinal keel body are connected by a fastener, a conceding space is formed between the conceding portion and the protective strip, the clamping portion is clamped on the protective strip. The fixed portion is convenient to connect the positioning bar to the horizontal keel or the longitudinal keel. The conceding space is used to reserve space for the pin shaft. At the same time, the conceding portion is used to resist the pin shaft to avoid interference and detachment. The clamping portion is used for clamping the positioning bar, thus, the installation and positioning of the protective strip are reliable.

Furtherly, the cross section of the protruding section includes a first connecting portion, a transition portion and a second portion, the first connecting portion extends from the outer end and extends to the outer side of the blade body, and the transition portion is connected to the outer end of the first connecting portion, the second connecting portion is connected to the transition portion and extends toward the inner surface of the blade body. When the louver blades are opened, the first connecting portion has a guiding effect on rain and wind, and guides rain or wind to the outer surface of the blade body, meanwhile, an included angle is formed between the second connecting portion and a vertical line to guide rain and wind to the outside, so as to more effectively prevent rain and wind from entering the room.

Furtherly, a sealing structure is provided at the outer end of the blade body; the sealing structure includes a sealing strip fixing portion and a matching portion connected to the outer end of the sealing strip fixing portion; the cross section of the mating portion is in the shape of a circular arc with a middle portion protruding to the outdoor side; the cross section of the sealing strip fixing portion is two limiting plates, and the two limiting plates extend outward from the outer end of the blade body, a sealing strip clamping groove is formed between the two limiting plates. The sealing strip fixing part is used to fix the sealing strip, and the function of the matching portion is to make the arc-shaped matching portion fit with the outer wall of the end of the swing shaft end after the louver blade is closed. The sealing performance between adjacent louver blades is further improved, and the sealing strip can be easily clamped and fixed through the sealing strip clamping groove.

Furtherly, a baffle is provided on the outer surface of the blade body close to the swing shaft end, and the baffle extends toward the outer side of the blade body. When the louver blades are opened, rain and wind will be blocked, reducing the possibility of rain or wind from entering the room.

Furtherly, the blade body includes two blade plates, a transverse slot is formed between the two blade plates, a window communicating with the transverse slot is provided on the blade plate, and a transparent plate is inserted into the transverse slot. Due to the transverse slot, it is convenient to install and remove the transparent plate. Due to the transparent plate, the indoor brightness is improved when the louver blades are opened or closed.

Furtherly, a switch device is provided between at least one louver blade and the longitudinal roof beam; the switch device includes a driving wheel and a driving rod; the driving wheel is fixed on the louver blade, the rotation center of the driving wheel is coaxial with the center of the pin accommodating hole, and the driving wheel is a worm gear; the driving rod passes through the frame, and the driving rod is a worm, which is engaged with the worm gear. The switch device has a simple structure and is reliably driven.

Furtherly, the linkage connection position is a hinge hole, a waist-shaped hole is provided on the linkage bar corresponding to the hinged hole, and a pin passes through the hinged hole and the waist-shaped hole. Due to the errors in the processing of the louver blade and the linkage bar, the louver blade has a certain error after installation. When the waist-shaped hole is adopted, the waist-shaped hole is located in a certain adjustment space of the pin, thus, the connection between the linkage bar and the louver blade is convenient, and there is no need to consider the errors of each component.

In accordance with another aspect of the embodiment, there is provided a louver blade, comprising: a blade body, wherein, the blade body is provided with a swing shaft end and an outer swing end, the swing shaft end is located at one end of the blade body, the outer swing end is located at the other end of the blade body, a pin accommodating hole is provided at the swing shaft end, the outer swing end is provided with a protruding section protruding to the outer side of the wall, a linkage connection position is defined on the protruding section; a sealing structure is provided at the outer end of the blade body; the sealing structure includes a sealing strip fixing portion and a matching portion connected to the outer end of the sealing strip fixing portion; the cross section of the mating portion is in the shape of a circular arc with a middle portion protruding to the outdoor side; the cross section of the sealing strip fixing portion is two limiting plates, and the two limiting plates extend outward from the outer end of the blade body, a sealing strip clamping groove is formed between the two limiting plates, a sealing strip is defined in the sealing strip clamping groove.

In the present invention, the linkage connection position is used to connect the linkage bar that allows all louver blades to swing synchronously. When the linkage connection position is defined on the protruding section, compared with the prior art, there is no need to provide an avoidance position on the frame for installing the louver blade, which makes the sealing performance of the louver blade perform good without interference. Due to the protruding section, when louver blades are opened, the protruding section can effectively reduce the entry of wind and rain into the room. The sealing strip fixing part is used to fix the sealing strip, and the function of the matching portion is to make the arc-shaped matching portion fit with the outer wall of the end of the swing shaft end after the louver blade is closed. The sealing performance between adjacent louver blades is further improved, and the sealing strip can be easily clamped and fixed through the sealing strip clamping groove.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a perspective view of the shutter according to the first embodiment;

FIG. 2 is an exploded view of the shutter according to the first embodiment;

FIG. 3 is an exploded view of the shutter according to the first embodiment viewed from another perspective;

FIG. 4 is a schematic side view of the shutter according to the first embodiment after the louver blades are opened;

FIG. 5 is a cross-sectional view of A-A in FIG. 1;

FIG. 6 is an enlarged view of C in FIG. 5;

FIG. 7 is a cross-sectional view of the transverse keel;

FIG. 8 is a cross-sectional view of B-B in FIG. 4;

FIG. 9 is a schematic diagram of the longitudinal keel and the protective strip.;

FIG. 10 is a schematic cross-sectional view of the longitudinal keel;

FIG. 11 is a schematic cross-sectional view of an alternative of the longitudinal keel;

FIG. 11a is a schematic diagram of the third structure of the longitudinal keel;

FIG. 12 is a schematic diagram of the first louver blade;

FIG. 13 is a cross-sectional view of the first louver blade;

FIG. 14 is a schematic diagram of the second louver blade;

FIG. 15 is is a cross-sectional view of the second louver blade;

FIG. 16 is an enlarged view of D in FIG. 5;

FIG. 17 is an enlarged view of E in FIG. 4;

FIG. 18 is a cross-sectional view of the protective strip;

FIG. 18a is a schematic diagram of the longitudinal keel installed on the wall;

FIG. 18b is a schematic diagram of an alternative of the the longitudinal keel installed on the wall;

FIG. 19 is an enlarged view of F in FIG. 2;

FIG. 20 is a cross-sectional view of the switch device;

FIG. 21 is a schematic diagram of the roof with the linkage shutter;

FIG. 22 is an enlarged view of G in FIG. 21;

FIG. 23 is an exploded view of the roof with the linkage shutter

FIG. 24 is a schematic diagram of the longitudinal roof beam;

FIG. 25 is an enlarged view of H in FIG. 24;

FIG. 26 is a schematic diagram of the longitudinal keel;

FIG. 27 is an enlarged view of J in FIG. 26;

FIG. 28 is an exploded view of the louver blade and the longitudinal keel;

FIG. 29 is a schematic diagram of the protective strip according to the second embodiment;

FIG. 30 is a schematic diagram when the shutter is closed;

FIG. 31 is enlarged view of Q in FIG. 30.

### DETAILED DESCRIPTION OF THE INVENTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

### The First Embodiment

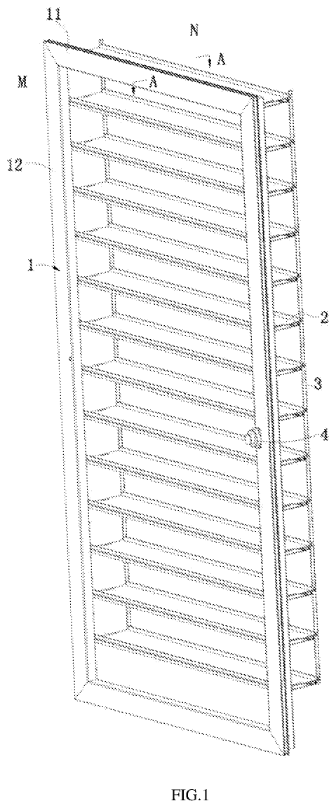

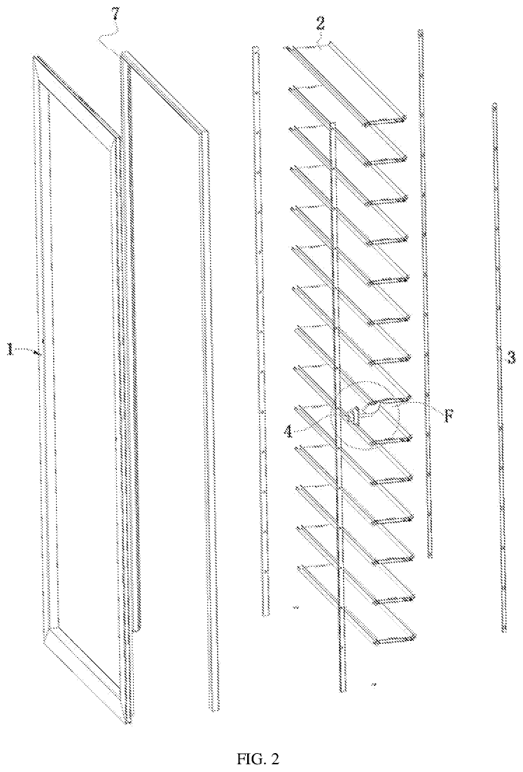

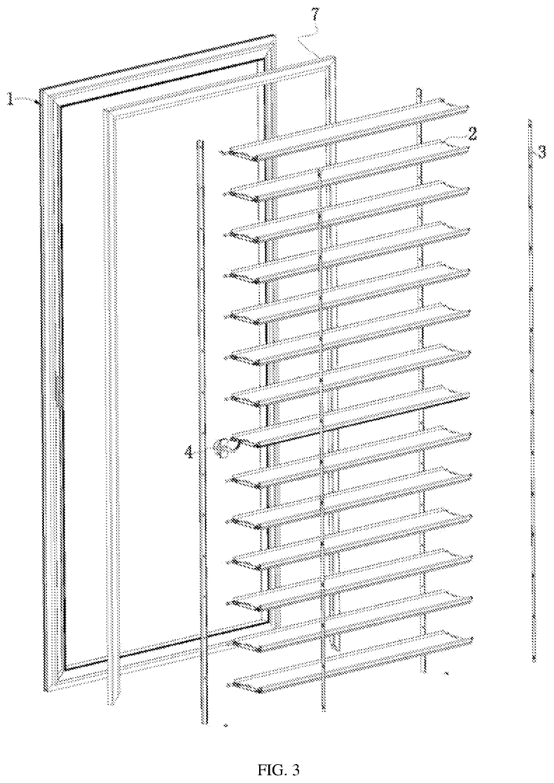

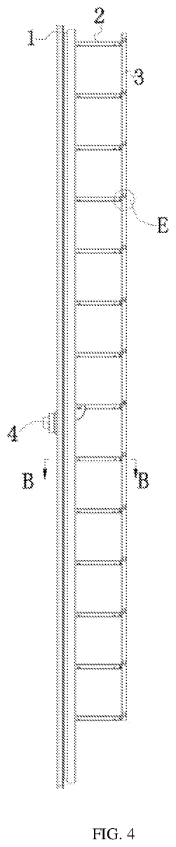

As shown in FIG. 1 to FIG. 4, a single-swinging shutter includes a frame 1, a pluralities of louvre blades 2, a linkage bar 3 and a switch device 4.

As shown in FIG. 1 to FIG. 3, the frame 1 includes a transverse keel 11 and a longitudinal keel 12. In the first embodiment, there are two transverse keels 11 and two longitudinal keels 12, and the two transverse keels 11 are connected with the two longitudinal keels 12 from head to tail to form a frame structure with a hollow in the middle.

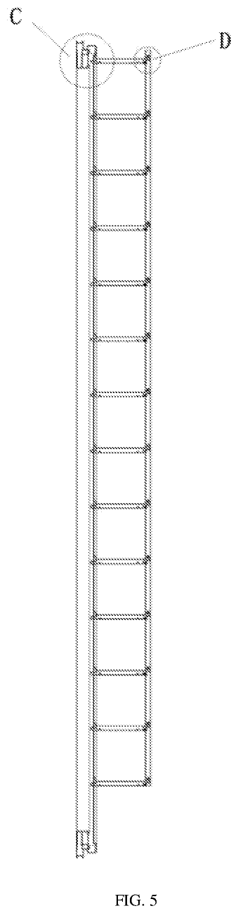

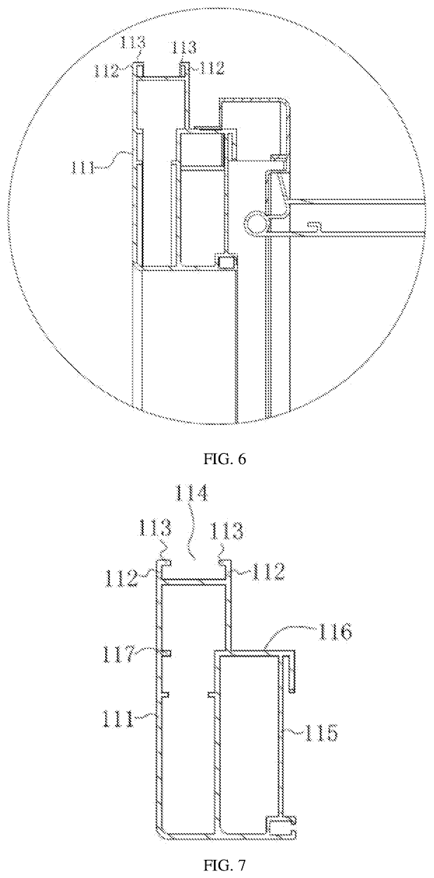

As shown in FIG. 5 to FIG. 7, the cross section of the transverse keel 11 includes a transverse keel body 111 and at least two extending portions 112, a limiting portion 113 and a transverse keel fixing portion 115, the extending portions 112 extend upward from the transverse keel body 111 and parallel to each other, the limiting portion 113 extends inward from the extending portions 112, the transverse keel fixing portion 115 is arranged on an outdoor side of the transverse keel body 111, a fixed step surface 116 is formed between the outdoor side of the transverse keel body 111 and the lateral keel fixing portion 115. The transverse keel body 111 is hollow, and transverse keel ribs 117 are provided on the inner wall of the transverse keel body 111 to improve the strength of the transverse keel 11. In the first embodiment, there are two extending portions 112, there is a space 114 between the limiting portions 113.

In the present invention, as shown in FIG. 1, M refers to an indoor side, and N refers to the outdoor side.

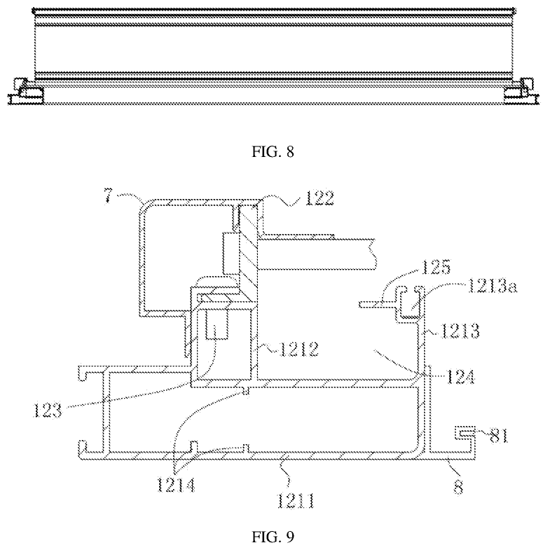

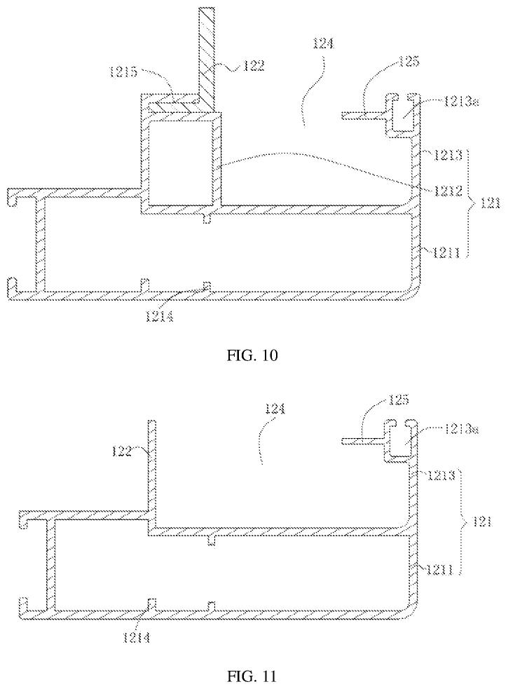

As shown in FIG. 8 to FIG. 11 and FIG. 11a, the longitudinal keel 12 includes a longitudinal keel body 121 and a positioning bar 122 protruding outward from the outdoor side of the longitudinal keel body 121.

One of the structures of the longitudinal keel 12 is as shown in FIG. 8 to FIG. 10. The longitudinal keel body 121 includes a keel beam 1211, a ridge 1212 and a stiffened plate 1213, the ridge 1212 protrudes from the outdoor side of the keel beam 1211, the stiffened plate 1213 protrudes from the keel beam 1211 to the outdoor side and is located on the side close to the frame space. The keel beam 1211 is a hollow structure, and keel ribs 1214 are provided on the inner wall of the keel beam 1211 to improve the bending and torsion resistance of the longitudinal keel 12. On the ridge 1212, a locking groove 1215 is provided at the outdoor side end of the ridge 1212 with an opening facing the side of the frame space, the section of the positioning bar 122 is L-shaped, one end of the positioning bar is clamped in the locking grove 1215, the other end of the positioning bar faces the outdoor side, a positioning bar fastener is provided between the positioning bar 122 and the ridge 1212. In this embodiment, the positioning bar fastener is a screw 123. The positioning bar 122 is provided with the same number of pin holes as the louver blades 2. A drainage groove 124 is formed between the ridge 1212 and the stiffened plate 1213. A drainage groove 124 is formed between the ridge 1212 and the stiffened plate 1213.

A sealing strip groove 1213a is longitudinally extended at the outer end of the stiffened plate 1213, and the sealing strip groove 1213a is clamped with a longitudinal sealing strip (not shown) which is in contact with the louver blade 2.

In the present invention, the pin hole on the positioning bar 122 is located beyond the outdoor side of the wall for installing the frame 1, and the drainage groove 124 is also located on the outdoor side of the wall for installing the frame 1.

In practical applications, the louver blade used is an outer unidirectionally swinging type, the louver blade 2 is hinged on the outer side of the frame 1, so that when the longitudinal keel 12 is formed, the positioning bar 122 for installing the louver blade 2 is provided on the outer side of the longitudinal keel 12, and the pin hole is provided on the positioning bar 122. The process is to first form the longitudinal keel 12, and then process the pin hole. Due to the longitudinal keel 12 with the above structure, the positioning bar 122 is movably connected to the longitudinal keel body 121, the pin hole can be machined on the positioning bar 122 and then installed on the longitudinal keel body 121, reducing the processing cost and difficulty. As an alternative of the longitudinal keel 12, as shown in FIG. 11, the positioning bar 122 and the longitudinal keel body 121 are integral. The longitudinal keel body 121 includes a keel beam 1211, and a stiffened plate 1213, the stiffened plate 1213 protrudes from the keel beam 1211 to the outdoor side and is located on the side close to the frame space. A drainage groove 124 is formed between the positioning bar and the stiffened plate 1213. The keel beam 1211 is a hollow structure, and keel ribs 1214 are provided on the inner wall of the keel beam 1211 to improve the bending and torsion resistance of the longitudinal keel 12. A sealing strip groove 1213a is longitudinally extended at the outer end of the stiffened plate 1213, and the sealing strip groove 1213a is clamped with a longitudinal sealing strip (not shown) which is in contact with the louver blade 2.

A second blocking portion 125 is provided on the stiffened plate 1213, and is located outside the drainage groove 124 at the side of the drainage groove 124 close to the frame space.

As shown in FIG. 11a, it is the third structure of the longitudinal keel 12, and the positioning bar 122 and the longitudinal keel body 121 are an integral structure. The positioning bar 122 extends from the longitudinal keel body 121 to the outdoor side.

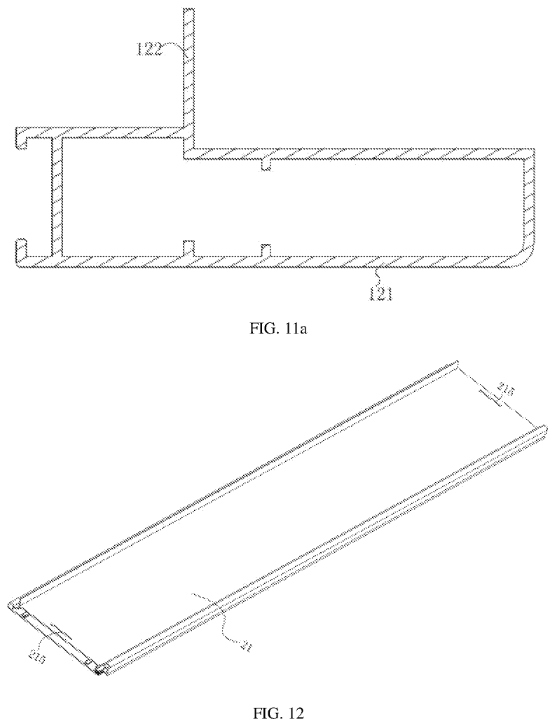

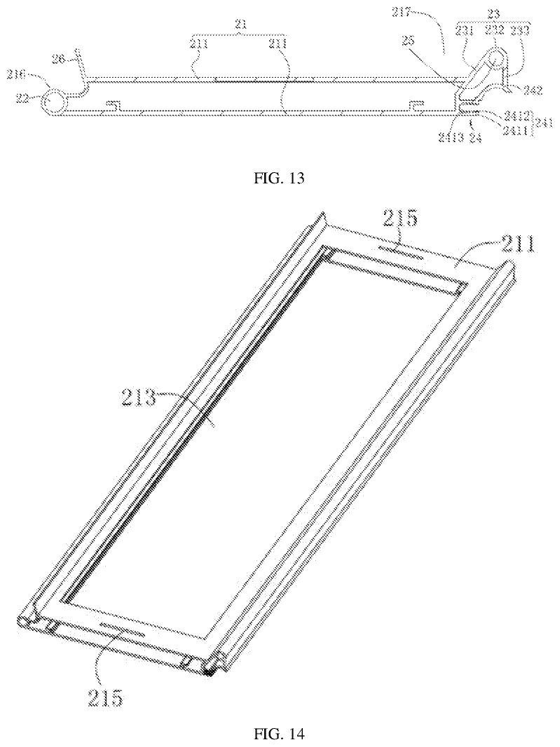

As shown in FIG. 12 and FIG. 13, the louver blade 2 includes a blade body 21, the length of the blade body 21 is greater than the distance between the inner sides of two longitudinal keel bodies 121, and the blade body 21 includes two blade plates 211. As an alternative as shown in FIG. 14 and FIG. 15, a support bar 214 is provided on the blade plate 211 on the inner side and in a transverse slot, and the cross section of the support bar 214 is L-shaped; the transverse slot 212 is formed between the two blade plates 211, a window 213 communicating with the transverse slot is provided on the blade plate 211, and a transparent plate is inserted into the transverse slot 212. In this embodiment, the transparent plate is glass, and the transparent plate is in contact with the support bar 214. In this way, the contact area between the glass plate and the support bar 214 is small, which reduces the resistance of installing and disassembling the transparent plate, and supports the transparent plate better.

As shown in FIG. 12 and FIG. 14, two ends of the blade plate 211 located on the outer surface are respectively provided with a sluicing groove 215 communicating with the transverse slot 212. In this way, when there is rainwater on the louver blade 2, part of the rainwater will enter the transverse slot 212 from the sluicing groove 215, and then be discharged from both ends of the transverse slot 212 to facilitate drainage.

As shown in FIG. 12 to FIG. 15, the blade body 21 is provided with a swing shaft end 216 and an outer swing end 217, the swing shaft end 216 is located at one end of the blade body 21, the outer swing end 217 is located at the other end of the blade body 21, a pin accommodating hole 22 is provided at the swing shaft end 216, the outer wall of the swing shaft end 216 is circular, and the outer wall of the swing shaft end 216 is coaxial with the shaft center of the pin accommodating hole 22. In this way, the louver blades 2 will not be or interfered during rotation. The outer swing end 217 of the blade body 21 is provided with a protruding section 23 protruding to the outer side of the wall of the blade body 21, a linkage connection is defined on the protruding section 23; the cross section of the protruding section 23 includes a first connecting portion 231, a transition portion 232 and a second portion 233, the first connecting portion 231 extends from the blade body 21 away from the swing shaft end 216 and extends outwardly, and the transition portion 232 is connected to the outer end of the first connecting portion 231, The second connecting portion 233 is connected to the transition portion 231 and extends toward the inner surface of the blade body 21. Two ends of the protruding section 23 are respectively provided with a linkage connection position, and the linkage connection position is a hinge hole 25. The two ends of the protruding section 23 are respectively provided with a linkage connection position, and the linkage connection position is a hinge hole 25.

A sealing structure 24 is provided at the outer swing end 217 of the blade body 21; the sealing structure 24 includes a sealing strip fixing portion 241 and a matching portion 242 connected to the sealing strip fixing portion 241; the cross section of the sealing strip fixing portion 241 is two limiting plates 2411, and the two limiting plates 2411 extend outward from the outer end of the blade body 21, a sealing strip clamping groove 2413 is formed between the two limiting plates 2411, on the inner wall of the sealing strip clamping groove 2413 on the limiting plate 2411, there are provided clamping teeth 2412 inclined toward the inner end of the blade body 21. The cross section of the mating portion 242 is in the shape of a circular arc with a middle portion protruding from the outer side surface. The lower end of the second connecting portion 233 is connected to the matching portion 242.

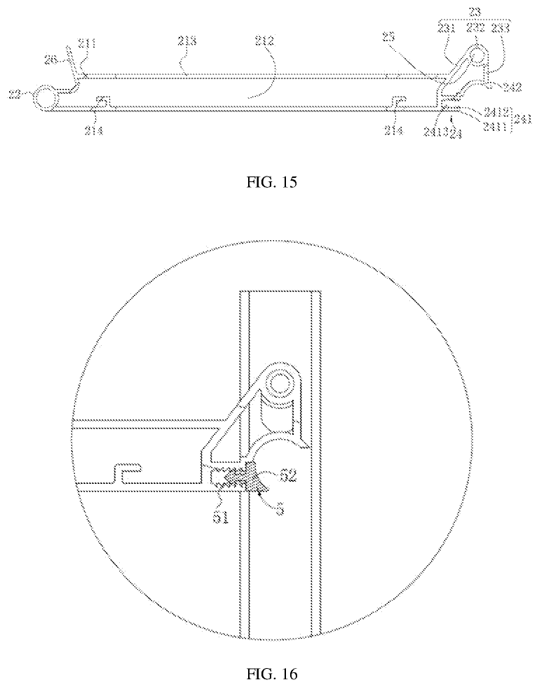

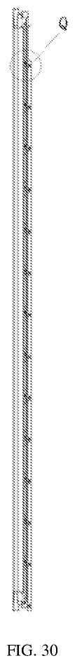

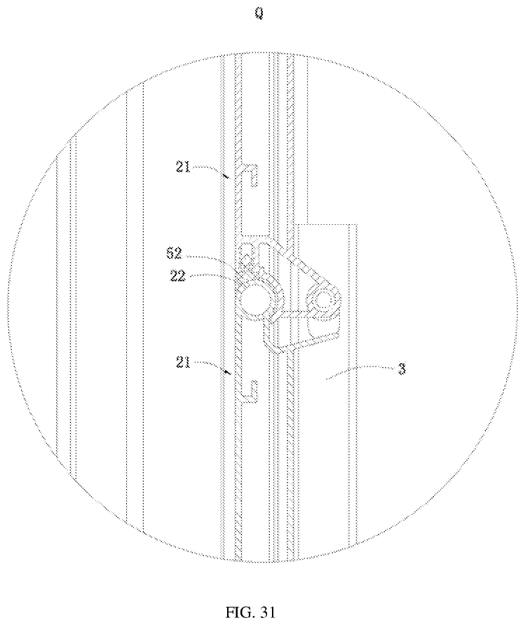

As shown in FIG. 16, a sealing strip 5 is clamped on the sealing strip clamping groove 2413. The sealing strip 5 includes a connecting portion 51 and a sealing portion 52. The connecting portion 51 is provided with a protruding teeth. With this structure, when the sealing strip 5 is installed in the sealing strip clamping groove 2413, the protruding teeth on the sealing strip 5 are matched with the clamping teeth 2412, and the reliability of the connection between the sealing strip 5 and the sealing strip fixing portion 241 is improved. In the viewing direction of FIG. 16, the sealing portion 52 is located below the matching portion 242, and the outer end of the sealing portion 52 is arc-shaped. In this way, the sealing portion 52 is combined with the matching portion 242. As shown in FIG. 30 and FIG. 31, when the louver blades 2 are closed, the arc-shaped cavity formed by the sealing portion 52 and the mating portion 242 is then clamped to the outer wall of the outer swing end 217 of the adjacent louver blades, so that the sealing performance is good.

As shown in FIG. 13 and FIG. 15, a baffle 26 is provided on the outer surface of the blade body 21 close to the swing shaft end 216, and the baffle 26 extends toward the outer side of the blade body 21, the baffle 26 is inclined from the inside to the outside toward the swing shaft end 216 of the blade body 21. With this structure, when the louver blades 2 are opened, it has a blocking effect on rain and wind, reducing rain or wind from entering the room.

The louver blade 2 is mounted on the positioning bar 122 by a pin shaft passing through the pin hole and the pin accommodating hole 22. The installation process is as follows, first align the pin accommodating hole 22 of the louver blade 2 with the pin hole, then, the pin shaft is passed through the pin hole and the pin accommodating hole 22 from the position of the positioning bar 122 away from the frame space, so that the hinged connection of the louver blade 2 is realized.

After the louver blade 2 is installed, in the transverse direction, the length of the louver blade 2 is greater than the distance between the inner sides of two longitudinal keels 12. Via the sealing strip 5 in the sealing strip groove 1213a, the gap between two ends of the louver blade 2 and the outer surface of the longitudinal keel 12 is sealed, and the gap between the upper and lower louver blade 2 is sealed.

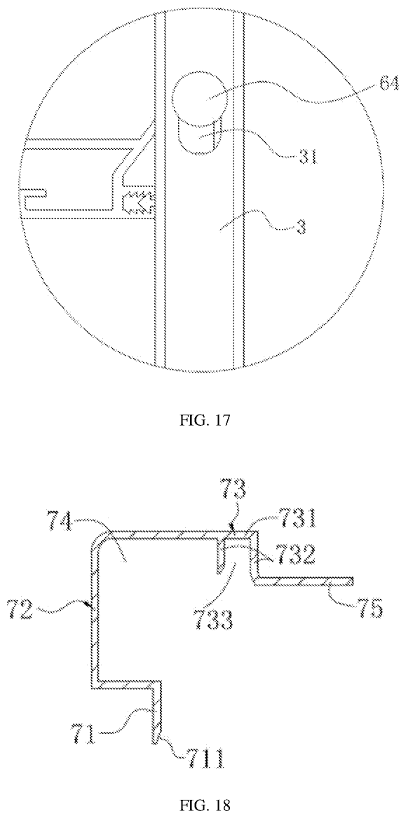

As shown in FIG. 1 to FIG. 4, along with FIG. 17, the hinge holes 25 of all the louver blades 2 in the same longitudinal direction are connected with the linkage bar 3 via a pin 61; on the linkage bar 3, the position corresponding to the pin 61 passing through is a waist-shaped hole 31. Based on this arrangement, due to the errors in the processing of the louver blade 2 and the linkage bar 3, the louver blade 2 has a certain error after installation. When the waist-shaped hole 31 is adopted, the waist-shaped hole 31 is located in a certain adjustment space of the pin 61, thus, the connection between the linkage bar 3 and the louver blade 2 is convenient, and there is no need to consider the errors of each component.

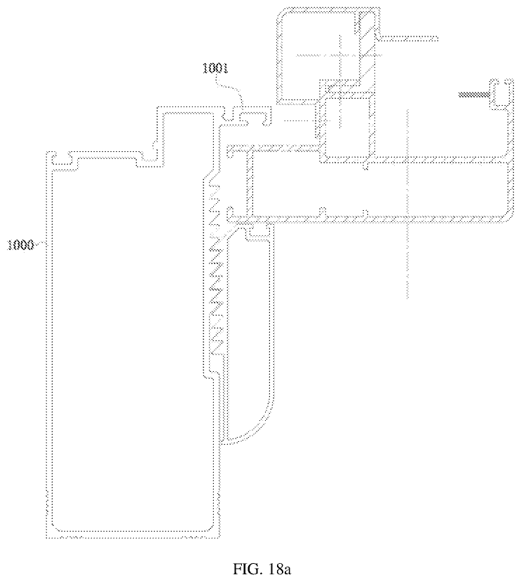

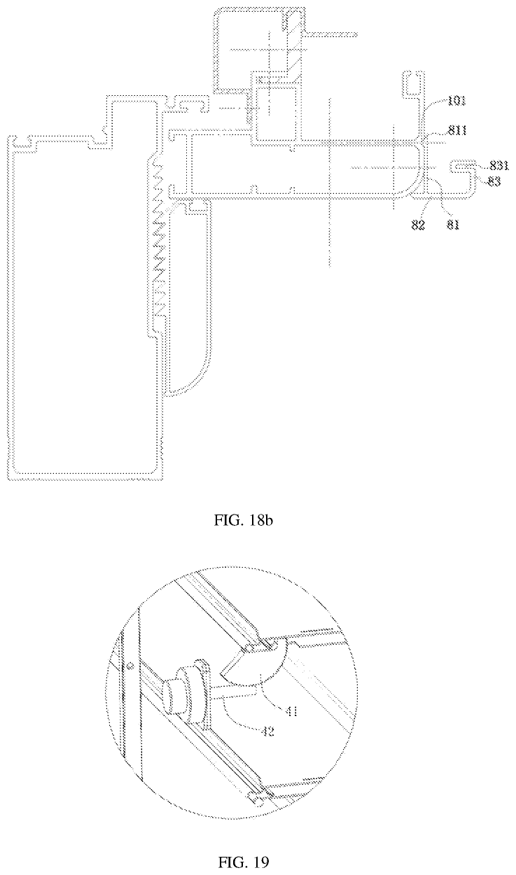

The longitudinal keel 12 and the uppermost transverse keel 11 are fixed with a protective strip 7 which shields and blocks the pin shaft on the outside. As shown in FIG. 9 and FIG. 18, the cross section of the protective strip 7 includes a fixed portion 71, a conceding portion 72 connected to the fixed portion 71, and a clamping portion 73 connected to the conceding portion 72. In the perspective of FIG. 18, the fixed portion 71 extends from bottom to top, and a chamfer 711 is provided on the inner side of the lower end of the fixed portion 71. Thus, when the protective strip 7 is installed on the longitudinal keel 12 or the horizontal keel 11, the chamfer 711 serves as a guide, which facilitates the installation of the protective strip 7. The conceding portion 72 first extends from the upper end of the fixed portion 71 to the left, then extends upward, then extends to the right and beyond the fixed portion 71, thus, a conceding space 74 is formed in the conceding portion 72, and the conceding space 72 is used for accommodating the head of the pin shaft, preventing the protective strip 7 from interfering with the pin shaft during the installation process, and also preventing the pin shaft from detaching. The clamping portion 73 includes a connecting plate 731 connected to the conceding portion 72 and two parallel clamping plates 732 extending downward from the connecting plate 731. A clamping slot 733 is formed between the two clamping plates 732. A chamfer 711 is provided on the inner side of the lower end to guide the insertion of the positioning bar 122. The fixed portion 71 and the longitudinal keel body 121 are connected by a fastener. In this embodiment, the fastener is a screw.

The protective strip 7 is provided with a first blocking portion 75 located on the outdoor side of the drainage groove 124, the first blocking portion 75 and the second blocking portion 125 are arranged staggered in the outdoor side direction, the projections of the first blocking portion 75 and the second blocking portion 125 in the indoor and outer directions may overlap, or may not overlap. The second blocking portion 125 is located near the indoor side of the first blocking portion 75.

As shown in FIG. 18a, the outdoor side of the wall 1000 has a resisting portion 1001, the resisting portion 1001 abuts against the frame 1, and the resisting portion 1001 blocks the fastener. Specifically, the outdoor side of the resisting portion 1001 is flush with the outdoor side of the fixed portion 71 or protruding from the outdoor side of the fixed portion 71, and the gap between the resisting portion 1001 and the conceding portion 72 is quite small. In this way, when the pin shaft passes through from the outside, for example, after the frame 1 and the louver blade 2 are integrally installed on the wall 1000, the resisting portion 1001 of the wall 1000 blocks the fasteners, therefore, the fasteners will not be removed from the outside at will.

As shown in FIG. 9 and FIG. 18b, an anti-mosquito net keel 8 is installed on an indoor side of the frame 1. The cross section of the anti-mosquito net keel 8 includes an inserting portion 81, an anti-mosquito net blocking portion 82, and an anti-mosquito net fixed portion 83. A positioning slot 101 is provided on the frame 1, and a positioning protrusion 811 locked into the positioning slot 101 is provided on the insertion portion 81. The anti-mosquito net blocking portion 82 is connected to the indoor side of the inserting portion 81, the anti-mosquito net blocking portion 82 leans against on the frame 1, and the anti-mosquito net fixed portion 83 is connected to the inserting portion 81 or the anti-mosquito net blocking portion 82. In this embodiment, the anti-mosquito net fixed portion 83 extends upward from one end of the anti-mosquito net blocking portion 82, then extends to the left, then upwards, and finally extends to the right, an anti-mosquito net slot 8831 is formed between the left and right extending portions, it is convenient to install the mosquito net, and it is convenient to quickly install and remove the mosquito net keel 8.

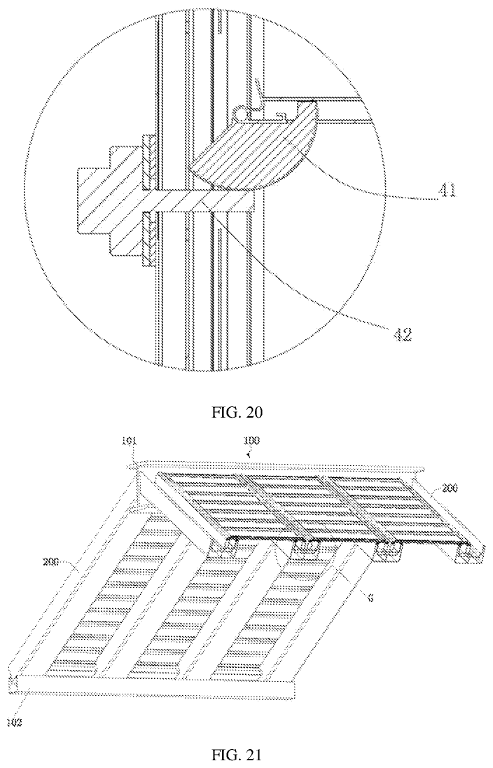

As shown in FIG. 19 and FIG. 20, a switch device 4 is provided between at least one louver blade 2 and the frame1. The switch device 4 includes a driving wheel 41 and a driving rod 42. The driving wheel 41 is fixed on the louver blade 2, the rotation center of the driving wheel 41 is coaxial with the center of the pin accommodating hole 22, and the driving wheel 41 is a worm gear. The driving rod 42 passes through the frame 1, and the driving rod 42 is a worm, which is engaged with the worm gear. The driving rod 42 is manually rotated or driven by a power such as an electric motor or a motor.

The shutter in this embodiment, if the driving rod is driven to rotate by hand or motor, the driving wheel is driven to rotate by the rotation of the driving rod, so as to realize the swing of the louver blades connected with the driving wheel, and then all the louver blades are driven to swing synchronously via the connecting rod to realize the opening and closing of shutter.

The louver blade in this embodiment is provided with the protruding section, the protruding section are defined protrudingly, and the linkage connecting position for connecting the linkage bar is arranged on the protruding section, the linkage connecting position is farther away from the wall compared with the pin accommodating hole. Compared with the prior art, there is no necessary to provide an avoidance position on the frame for installing the louver blade, that is, it can have good sealing performance after the louver blade is closed without interference. Due to the protruding section, when louver blades are opened, the protruding section can effectively reduce the entry of wind and rain into the room. For the swing-out shutter, the mounting holes for installing the louver blades are located beyond the outside of the wall, so that the louver blades can be installed and removed outdoors. Of course, the pin shaft is defined outdoors. In this case, the protective strip is provided for better anti-theft. In the above structure, the louver blades are located outside the wall. Therefore, after the louver blades are opened, even if the rainwater leaks from the inner end of the louver blades, the rainwater will be discharged from the outside and will not enter the room, so that the discharge performance of the whole shutter is very good.

Due to the transparent plate, the indoor brightness is improved when the louver blades are opened or closed. Due to the transverse slot, it is convenient to install and remove the transparent plate. The support bar is used to support the transparent plate, so that the contact area between the transparent plate and the support bar is small, which reduces the resistance of installing and disassembling the transparent plate, and better support the transparent plate.

Due to the drainage grooves, most of the rain and wind from the outside to the shutters will be guided to two sides via the louver blades and enter the drainage grooves, and there is no protective strip installed on the horizontal keel at the lower end, so that the rainwater will be better discharged from the drainage groove, and the wind flow can reduce the noise such as “whistle” at the louver blades. Since the first blocking portion and the second blocking portion are provided, in this way, it is possible to effectively prevent sundries and the like from entering the drainage groove and jamming the drainage groove. As shown in FIG. 9, after the louver blades are installed, the first blocking portion is basically located outside the closed louver blades, so that the water and wind on the louver blades will be better guided into the drainage groove.

In this embodiment, the pin shaft used to install the louver blade is installed from the outside, which facilitates the installation and removal of the pin shaft. The subsequent problem is that the pin is easy to be disassembled. To avoid this problem, a protective strip is installed by fixing the protective strip with screws from the inside, the pin shaft is covered by the protective strip. In this way, it can better play the role of anti-theft.

Due to the longitudinal sealing strip, when the louver blades are closed, the sealing effect is good, which can effectively prevent rainwater and wind from entering the room.

### The Second Embodiment

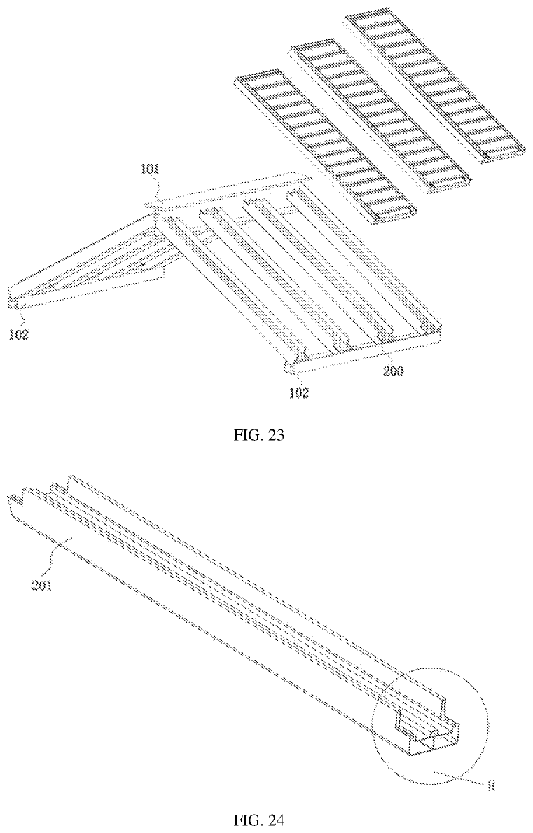

As shown in FIG. 21 to FIG. 23, a roof with the linkage shutter includes a transverse roof beam 100, a longitudinal roof beam 200, a louver blade 2, a linkage bar 3 and a switch device 4.

The roof beam 100 includes an upper roof beam 101 and a lower roof beam 102. The longitudinal roof beam 200 is connected between the roof upper beam 101 and the lower roof beam 102, and two or more longitudinal roof beams 200 are provided. In this embodiment, the roof is Inverted-V-shaped.

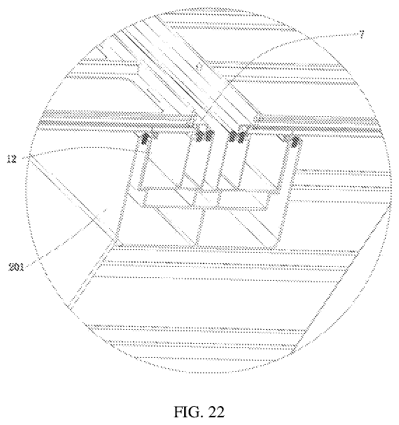

The roof beam 100 is an H-beam. As shown in FIG. 22, the longitudinal roof beam 200 includes a longitudinal roof beam body 201 and the longitudinal keel 12.

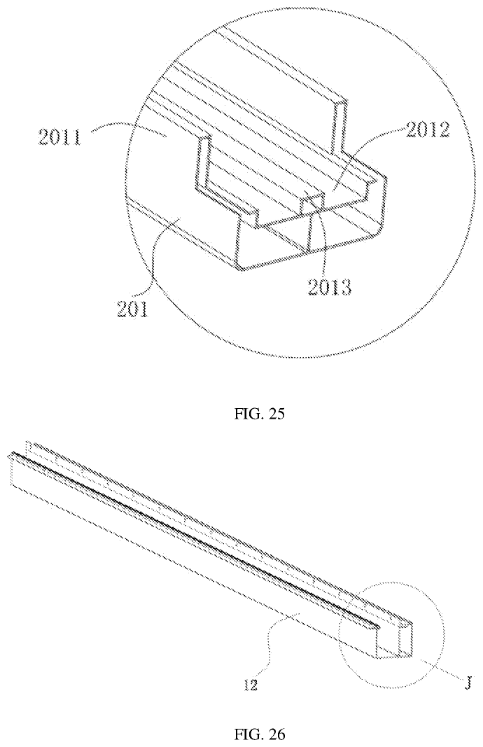

As shown in FIG. 24 and FIG. 25, two positioning plates 2011 extend upward from both sides of the longitudinal roof beam body 201, an accommodating slot 2012 is defined between the two positioning plates 2011, a spacer 2013 extending in the longitudinal direction is provided in the accommodating slot 2012, the spacer 2013 divides the accommodating slot 2012 into two small accommodating slot 2012, and the two small accommodating slot 2012 are used to place the longitudinal keel 12 respectively.

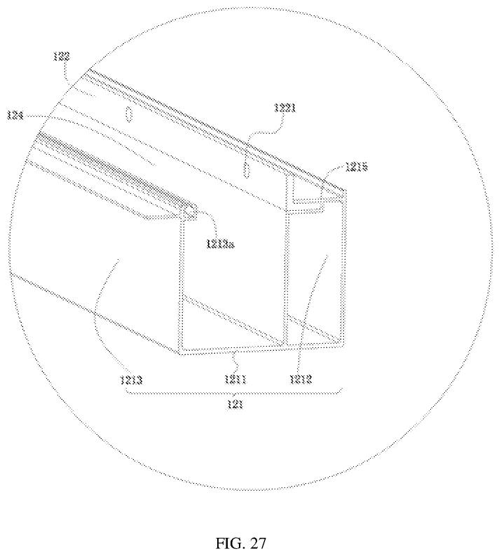

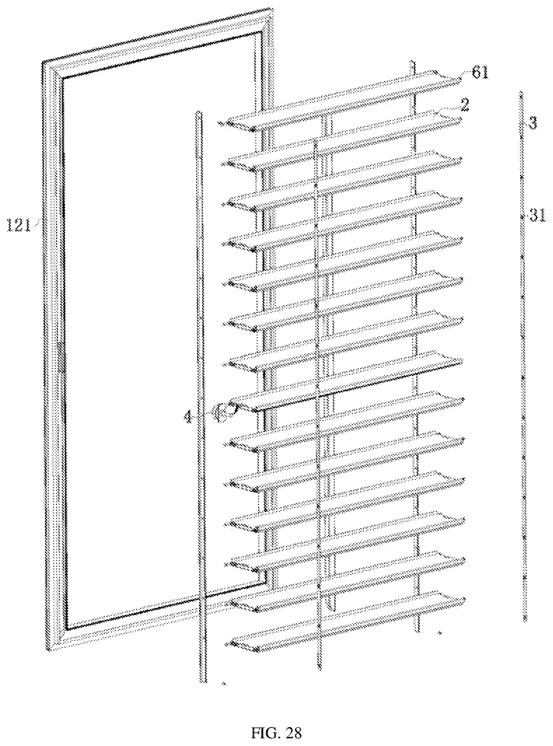

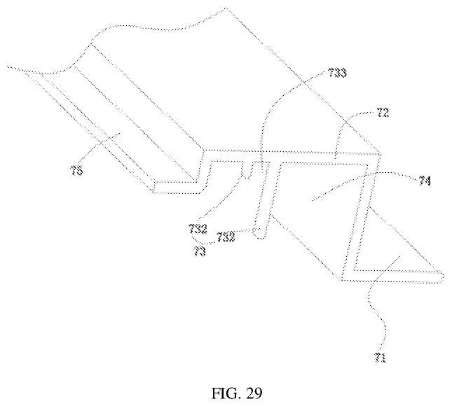

As shown in FIG. 26 and FIG. 27, the longitudinal keel 12 includes a longitudinal keel body 121 and a positioning bar 122 protrudes outward from the longitudinal keel body 121.

One of the structures of the longitudinal keel 12, as shown in FIG. 26 to FIG. 27. The longitudinal keel body 121 includes a keel beam 1211, a ridge 1212 and a stiffened plate 1213, the ridge 1212 protrudes from the outside of the keel beam 1211, the stiffened plate 1213 protrudes from the keel beam 1211 to the outside and is located on the side close to the louver blade 2. On the ridge 1212, a locking groove 1215 is provided at the outer end of the ridge 1212 with an opening towards one side of the louver blade 2, the section of the positioning bar 122 is L-shaped, one end of the positioning bar is clamped in the locking grove 1215, the other end of the positioning bar faces the outside, a positioning bar fastener is provided between the positioning bar 122 and the ridge 1212. In this embodiment, the positioning bar fastener is a screw 123. The positioning bar 122 is provided with the same number of pin holes 1221 as the louver blades 2. A drainage groove 124 is formed between the ridge 1212 and the stiffened plate 1213. A sealing strip groove 1213a is longitudinally extended at the outer end of the stiffened plate 1213, and the sealing strip groove 1213a is clamped with a longitudinal sealing strip (not shown) which is in contact with the louver blade 2.

In practical applications, the louver blade used is an outer unidirectionally swinging type, the louver blade 2 is hinged on the outer side of the longitudinal keel 12, so that when the longitudinal keel 12 is formed, the positioning bar 122 for installing the louver blade 2 is provided on the outer side of the longitudinal keel 12, and the pin hole is provided on the positioning bar 122. The process is to first form the longitudinal keel 12, and then process the pin hole. Due to the longitudinal keel 12 with the above structure, the positioning bar 122 is movably connected to the longitudinal keel body 121, the pin hole can be machined on the positioning bar 122 and then installed on the longitudinal keel body 121, reducing the processing cost and difficulty.

As an alternative of the longitudinal keel 12, the positioning bar 122 and the longitudinal keel body 121 are integral. The longitudinal keel body 121 includes a keel beam 1211, and a stiffened plate 1213, the stiffened plate 1213 protrudes from the keel beam 1211 to the outside and is located on the side close to the louver blade 2. A drainage groove 124 is formed between the positioning bar and the stiffened plate 1213. A sealing strip groove 1213a is longitudinally extended at the outer end of the stiffened plate 1213, and the sealing strip groove 1213a is clamped with a longitudinal sealing strip (not shown) which is in contact with the louver blade 2.

In the third structure of the longitudinal keel 12, the positioning bar 122 and the longitudinal keel body 121 are an integral structure. The positioning bar 122 extends from the longitudinal keel body 121 to the outside.

The longitudinal keel body 121 is provided with a positioning portion 123, and the positioning portion 123 is connected with the positioning plate 2011 by screws, which facilitates the installation and disassembly of the longitudinal keel 12 and the louver blade 2.

As shown in FIG. 12 and FIG. 13, the louver blade 2 includes a blade body 21, the length of the blade body 21 is greater than the distance between the inner sides of two longitudinal keel bodies 121, and the blade body 21 includes two blade plates 211. As an alternative as shown in FIG. 14 and FIG. 15, a support bar 214 is provided on the blade plate 211 on the inner side and in a transverse slot, and the cross section of the support bar 214 is L-shaped; the transverse slot 212 is formed between the two blade plates 211, a window 213 communicating with the transverse slot is provided on the blade plate 211, and a transparent plate is inserted into the transverse slot 212. In this embodiment, the transparent plate is glass, and the transparent plate is in contact with the support bar 214. In this way, the contact area between the glass plate and the support bar 214 is small, which reduces the resistance of installing and disassembling the transparent plate, and supports the transparent plate better.

As shown in FIG. 12 and FIG. 14, two ends of the blade plate 211 located on the outer surface are respectively provided with a sluicing groove 215 communicating with the transverse slot 212. In this way, when there is rainwater on the louver blade 2, part of the rainwater will enter the transverse slot 212 from the sluicing groove 215, and then be discharged from both ends of the transverse slot 212 to facilitate drainage.

As shown in FIG. 12 to FIG. 15, the blade body 21 is provided with a swing shaft end 216 and an outer swing end 217, the swing shaft end 216 is located at one end of the blade body 21, the outer swing end 217 is located at the other end of the blade body 21, a pin accommodating hole 22 is provided at the swing shaft end 216, the outer wall of the swing shaft end 216 is circular, and the outer wall of the swing shaft end 216 is coaxial with the shaft center of the pin accommodating hole 22. In this way, the louver blades 2 will not be or interfered during rotation. The outer swing end 217 of the blade body 21 is provided with a protruding section 23 protruding to the outer side of the wall of the blade body 21, a linkage connection is defined on the protruding section 23; the cross section of the protruding section 23 includes a first connecting portion 231, a transition portion 232 and a second portion 233, the first connecting portion 231 extends from the blade body 21 away from the swing shaft end 216 and extends outwardly, and the transition portion 232 is connected to the outer end of the first connecting portion 231, The second connecting portion 233 is connected to the transition portion 231 and extends toward the inner surface of the blade body 21. Two ends of the protruding section 23 are respectively provided with a linkage connection position, and the linkage connection position is a hinge hole 25. The two ends of the protruding section 23 are respectively provided with a linkage connection position, and the linkage connection position is a hinge hole 25.

A sealing structure 24 is provided at the outer swing end 217 of the blade body 21; the sealing structure 24 includes a sealing strip fixing portion 241 and a matching portion 242 connected to the sealing strip fixing portion 241; the cross section of the sealing strip fixing portion 241 is two limiting plates 2411, and the two limiting plates 2411 extend outward from the outer end of the blade body 21, a sealing strip clamping groove 2413 is formed between the two limiting plates 2411, on the inner wall of the sealing strip clamping groove 2413 on the limiting plate 2411, there are provided clamping teeth 2412 inclined toward the inner end of the blade body 21. The cross section of the mating portion 242 is in the shape of a circular arc with a middle portion protruding from the outer side surface. The lower end of the second connecting portion 233 is connected to the matching portion 242.

As shown in FIG. 16, a sealing strip 5 is clamped on the sealing strip clamping groove 2413. The sealing strip 5 includes a connecting portion 51 and a sealing portion 52. The connecting portion 51 is provided with a protruding teeth. With this structure, when the sealing strip 5 is installed in the sealing strip clamping groove 2413, the protruding teeth on the sealing strip 5 are matched with the clamping teeth 2412, and the reliability of the connection between the sealing strip 5 and the sealing strip fixing portion 241 is improved. In the viewing direction of FIG. 16, the sealing portion 52 is located below the matching portion 242, and the outer end of the sealing portion 52 is arc-shaped. In this way, the sealing portion 52 is combined with the matching portion 242. As shown in FIG. 30 and FIG. 31, when the louver blades 2 are closed, the arc-shaped cavity formed by the sealing portion 52 and the mating portion 242 is then clamped to the outer wall of the outer swing end 217 of the adjacent louver blades, so that the sealing performance is good.

As shown in FIG. 13 and FIG. 15, a baffle 26 is provided on the outer surface of the blade body 21 close to the swing shaft end 216, and the baffle 26 extends toward the outer side of the blade body 21, the baffle 26 is inclined from the inside to the outside toward the swing shaft end 216 of the blade body 21. With this structure, when the louver blades 2 are opened, it has a blocking effect on rain and wind, reducing rain or wind from entering the room.

The louver blade 2 is mounted on the positioning bar 122 by a pin shaft passing through the pin hole and the pin accommodating hole 22. The installation process is as follows, first align the pin accommodating hole 22 of the louver blade 2 with the pin hole, then, the pin shaft is passed through the pin hole and the pin accommodating hole 22 from the position of the positioning bar 122 away from the frame space, so that the hinged connection of the louver blade 2 is realized.

After the louver blade 2 is installed, in the transverse direction, the length of the louver blade 2 is greater than the distance between the inner sides of two longitudinal keels 12. Via the sealing strip 5 in the sealing strip groove 1213a, the gap between two ends of the louver blade 2 and the outer surface of the longitudinal keel 12 is sealed, and the gap between the upper and lower louver blade 2 is sealed.

As shown in FIG. 1 to FIG. 4, along with FIG. 17, the hinge holes 25 of all the louver blades 2 in the same longitudinal direction are connected with the linkage bar 3 via a pin 61; on the linkage bar 3, the position corresponding to the pin 61 passing through is a waist-shaped hole 31. Based on this arrangement, due to the errors in the processing of the louver blade 2 and the linkage bar 3, the louver blade 2 has a certain error after installation. When the waist-shaped hole 31 is adopted, the waist-shaped hole 31 is located in a certain adjustment space of the pin 61, thus, the connection between the linkage bar 3 and the louver blade 2 is convenient, and there is no need to consider the errors of each component.

As shown in FIG. 22 and FIG. 29, the longitudinal keel 12 is fixed with a protective strip 7 to cover the installation position on the outside. The cross section of the protective strip 7 includes a fixed portion 71, a conceding portion 72 connected to the fixed portion 71, and a clamping portion 73 connected to the conceding portion 72. In the perspective of FIG. 29, the fixed portion 71 extends from right to left, the conceding portion 72 first extends upward from the left end of the fixed portion 71, then extends to the left, thus, a conceding space 74 is formed in the conceding portion 72, and the conceding space 72 is used for accommodating the head of the pin shaft, preventing the protective strip 7 from interfering with the pin shaft during the installation process, and also preventing the pin shaft from detaching. The clamping portion 73 includes two parallel clamping plates 732 extending downward from the conceding space 72. A clamping slot 733 is formed between the two clamping plates 732. A chamfer 711 is provided on the inner side of the lower end to guide the insertion of the positioning bar 122. The fixed portion 71 and the longitudinal keel body 121 are connected by a fastener. In this embodiment, the fastener is a screw.

The protective strip 7 is provided with a first blocking portion 75 located on the outside of the drainage groove 124

As shown in FIG. 19 and FIG. 20, a switch device 4 is provided between at least one louver blade 2 and the frame1. The switch device 4 includes a driving wheel 41 and a driving rod 42. The driving wheel 41 is fixed on the louver blade 2, the rotation center of the driving wheel 41 is coaxial with the center of the pin accommodating hole 22, and the driving wheel 41 is a worm gear. The driving rod 42 passes through the frame 1, and the driving rod 42 is a worm, which is engaged with the worm gear. The driving rod 42 is manually rotated or driven by a power such as an electric motor or a motor.

The roof with the linkage shutter in this embodiment, if the driving rod is driven to rotate by hand or motor, the driving wheel is driven to rotate by the rotation of the driving rod, so as to realize the swing of the louver blades connected with the driving wheel, and then all the louver blades are driven to swing synchronously via the connecting rod to realize the opening and closing of louver blade of the roof.

The louver blade in this embodiment is provided with the protruding section, the protruding section are defined protrudingly, and the linkage connecting position for connecting the linkage bar is arranged on the protruding section, the linkage connecting position is farther away from the longitudinal roof beam compared with the pin accommodating hole. Compared with the prior art, there is no necessary to provide an avoidance position on the longitudinal keel for installing the louver blade, that is, it can have good sealing performance after the louver blade is closed without interference. Due to the protruding section, when louver blades are opened, the protruding section can effectively reduce the entry of wind and rain into the room. For the roof with the linkage shutter, the mounting holes for installing the louver blades are located beyond the outside of the wall, so that the louver blades can be installed and removed outdoors. Of course, the pin shaft is defined outdoors. In this case, the protective strip is provided for better anti-theft. In the above structure, the louver blades are located beyond the longitudinal roof beam body. Therefore, after the louver blades are opened, even if the rainwater leaks from the inner end of the louver blades, the rainwater will be discharged from the outside and will not enter the room, so that the discharge performance of the whole shutter is very good.

Due to the transparent plate, when the louver blades are opened or closed, the indoor brightness is improved. Due to the transverse slot, it is convenient to install and remove the transparent plate. The support bar is used to support the transparent plate, so that the contact area between the transparent plate and the support bar is small, which reduces the resistance of installing and disassembling the transparent plate, and better support the transparent plate.

Due to the drainage grooves, most of the rain and wind from the outside to the roof with the linkage shutter will be guided to two sides via the louver blades and enter the drainage grooves, so that the rainwater will be better discharged from the drainage groove, and the wind flow can reduce the noise such as “whistle” at the louver blades.

In this embodiment, the pin shaft used to install the louver blade is installed from the outside, which facilitates the installation and removal of the pin shaft. The subsequent problem is that the pin is easy to be disassembled. To avoid this problem, a protective strip is installed by fixing the protective strip with screws from the inside, the pin shaft is covered by the protective strip. In this way, it can better play the role of anti-theft.

Due to the longitudinal sealing strip, when the louver blades are closed, the sealing effect is good, which can effectively prevent rainwater and wind from entering the room.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

1. An unidirectionally swinging linkage shutter, comprising:
a frame and
a louver blade;
the frame includes a transverse keel and a longitudinal keel; wherein, the longitudinal keel includes a longitudinal keel body and a positioning bar, the positioning bar protrudes from the longitudinal keel body towards an outdoor side, the positioning bar is provided with the same number of pin holes as the louver blades, the pin hole is located beyond the outdoor side of a wall used to install the longitudinal keel body; the louver blade includes a blade body, the length of the blade body is greater than the distance between the inner sides of two longitudinal keel bodies, the blade body is provided with a swing shaft end and an outer swing end, the swing shaft end is located at one end of the blade body, the outer swing end is located at the other end of the blade body, a pin accommodating hole is provided at the swing shaft end, the outer swing end is provided with a protruding section protruding to the outer side of the wall, a linkage connection position is defined on the protruding section; when the louver blade is closed, all the linkage connection positions are farther away from the outer side of the wall than all the pin accommodating holes; the louver blade is hinged to the positioning bar via a pin shaft passing through the pin hole and the pin accommodating hole, on the linkage connection position of all the louver blades in the same longitudinal direction is provided with a linkage bar, the linkage bar is located on the outdoor side, and the linkage connecting bar is farther away from the outdoor side than the pin hole; a protective strip is fixed on the longitudinal keel to block the pin shaft on the outdoor side.

2. The shutter as set forth in claim 1, wherein: a drainage groove is arranged on the longitudinal keel body on the side of the positioning bar close to the louver blade, and a drainage groove is located on the outdoor side of the wall for installing the longitudinal keel body.

3. The shutter as set forth in claim 2, wherein: the longitudinal keel body includes a keel beam, a ridge and a stiffened plate, the ridge protrudes from the outside of the keel beam, the stiffened plate protrudes from the keel beam to the outdoor side and is located on the side close to the louver blade, the positioning bar is connected on the ridge, the drainage groove is formed between the ridge and the stiffened plate.

4. The shutter as set forth in claim 3, wherein: a sealing strip groove is longitudinally extended at the outdoor side of the stiffened plate, and the sealing strip groove is clamped with a longitudinal sealing strip which is in contact with the louver blade.

5. The shutter as set forth in claim 3, wherein a locking groove is provided at the outdoor side end of the ridge, one end of the positioning bar is clamped in the locking grove, the other end of the positioning bar faces the outdoor side, a positioning bar fastener is provided between the positioning bar and the ridge.

6. The shutter as set forth in claim 1, wherein the cross section of the protective strip includes a fixed portion, a conceding portion connected to the fixed portion, and a clamping portion connected to the conceding portion, the fixed portion and the longitudinal keel body are connected by a fastener, a conceding space is formed between the conceding portion and the protective strip, the clamping portion is clamped on the protective strip.

7. The shutter as set forth in claim 6, wherein the fixed portion is positioned on the side wall of the longitudinal keel body by a fastener passing from the wall to the direction of the louver blade, the outdoor side of the wall has a resisting portion, the resisting portion abuts against the frame, and the resisting portion blocks the fastener.

8. The shutter as set forth in claim 3, wherein the protective strip is provided with a first blocking portion located on the outdoor side of the drainage groove, the longitudinal keel body is provided with a second blocking portion located on the outdoor side of the drainage groove on the side of the drainage groove close to the louver blade, the first blocking portion and the second blocking portion are staggered in the outdoor side direction.

9. The shutter as set forth in claim 1, wherein an anti-mosquito net keel is installed on an indoor side of the frame, the cross section of the anti-mosquito net keel includes an inserting portion, an anti-mosquito net blocking portion, and an anti-mosquito net fixed portion; a positioning slot is provided on the frame, and a positioning protrusion locked into the positioning slot is provided on the insertion portion; the anti-mosquito net blocking portion is connected to the indoor side of the inserting portion, the anti-mosquito net blocking portion leans against on the frame, and the anti-mosquito net fixed portion is connected to the inserting portion or the anti-mosquito net blocking portion.

10. The shutter as set forth in claim 1, wherein the cross section of the protruding section includes a first connecting portion, a transition portion and a second portion, the first connecting portion extends from the outer end of the blade body and extends to the outer side of the blade body, and the transition portion is connected to the outer end of the first connecting portion, the second connecting portion is connected to the transition portion and extends toward the inner surface of the blade body.

11. The shutter as set forth in claim 1, wherein a sealing structure is provided at the other end of the blade body; the sealing structure includes a sealing strip fixing portion and a matching portion connected to the outer end of the sealing strip fixing portion; the cross section of the mating portion is in the shape of a circular arc with a middle portion protruding to the outdoor side; the cross section of the sealing strip fixing portion is two limiting plates, and the two limiting plates extend outward from the outer end of the blade body, a sealing strip clamping groove is formed between the two limiting plates.

12. The shutter as set forth in claim 1, wherein a baffle is provided on the outer surface of the blade body close to the swing shaft end, and the baffle extends toward the outer side of the blade body.

13. The shutter as set forth in claim 1, wherein the blade body includes two blade plates, a transverse slot is formed between the two blade plates, a window communicating with the transverse slot is provided on the blade plate, and a transparent plate is inserted into the transverse slot.

14. The shutter as set forth in claim 1, wherein a switch device is provided between at least one louver blade and the frame; the switch device includes a driving wheel and a driving rod; the driving wheel is fixed on the louver blade, the rotation center of the driving wheel is coaxial with the center of the pin accommodating hole, and the driving wheel is a worm gear; the driving rod passes through the frame, and the driving rod is a worm, which is engaged with the worm gear.

15. The shutter as set forth in claim 1, wherein the linkage connection position is a hinge hole, a waist-shaped hole is provided on the linkage bar corresponding to the hinged hole, and a pin passes through the hinged hole and the waist-shaped hole.

16. A roof with the linkage shutter, comprising:
a transverse roof beam and
a longitudinal roof beam, the longitudinal roof beam is arranged on the transverse roof beam; there are more than two longitudinal roof beams; wherein,
a louver blade is arranged between adjacent longitudinal roof beams; the longitudinal roof beam includes a longitudinal keel, the longitudinal keel includes a longitudinal keel body and a positioning bar, the positioning bar protrudes from the longitudinal keel body towards an outdoor side, the positioning bar is provided with the same number of pin holes as the louver blades, the louver blade includes a blade body, the length of the blade body is greater than the distance between the inner sides of two longitudinal keel bodies, the blade body is provided with a swing shaft end and an outer swing end, the swing shaft end is located at one end of the blade body, the outer swing end is located at the other end of the blade body, a pin accommodating hole is provided at the swing shaft end, the outer swing end is provided with a protruding section protruding to the outer side of the wall, a linkage connection position is defined on the protruding section; when the louver blade is closed, all the linkage connection positions are farther away from the outer side of the longitudinal roof beam than all the pin accommodating holes; the louver blade is hinged to the positioning bar via a pin shaft passing through the pin hole and the pin accommodating hole, on the linkage connection position of all the louver blades in the same longitudinal direction is provided with a linkage bar, the linkage bar is located on the outdoor side, and the linkage connecting bar is farther away from the outdoor side than the pin hole; a protective strip is fixed on the longitudinal keel to block the pin shaft on the outdoor side.

17. The roof as set forth in claim 16, wherein the longitudinal roof beam includes a longitudinal roof beam body, two positioning plates extend upward from both sides of the longitudinal roof beam body, an accommodating slot is defined between the two positioning plates; the longitudinal keel body is provided with a positioning portion, the longitudinal keel body is received in the accommodating slot, the positioning portion is connected with the positioning plate.

18. The roof as set forth in claim 16, wherein a drainage groove is arranged on the longitudinal keel body on the side of the positioning bar close to the louver blade,

19. The roof as set forth in claim 18, wherein the longitudinal keel body includes a keel beam, a ridge and a stiffened plate, the ridge protrudes from the outside of the keel beam, the stiffened plate protrudes from the keel beam to the outdoor side and is located on the side close to the louver blade, the positioning bar is movably connected on the ridge, the drainage groove is formed between the ridge and the stiffened plate.

20. The roof as set forth in claim 19, wherein a sealing strip groove is longitudinally extended at the outside of the stiffened plate, and the sealing strip groove is clamped with a longitudinal sealing strip which is in contact with the louver blade.

21. The roof as set forth in claim 19, wherein a locking groove is provided at the outside end of the ridge, one end of the positioning bar is clamped in the locking grove, the other end of the positioning bar faces the outside, a positioning bar fastener is provided between the positioning bar and the ridge.

22. The roof as set forth in claim 16, wherein the cross section of the protective strip includes a fixed portion, a conceding portion connected to the fixed portion, and a clamping portion connected to the conceding portion, the fixed portion and the longitudinal keel body are connected by a fastener, a conceding space is formed between the conceding portion and the protective strip, the clamping portion is clamped on the protective strip.

23. The roof as set forth in claim 16, wherein the cross section of the protruding section includes a first connecting portion, a transition portion and a second portion, the first connecting portion extends from the outer end of the blade body and extends to the outer side of the blade body, and the transition portion is connected to the outer end of the first connecting portion, the second connecting portion is connected to the transition portion and extends toward the inner surface of the blade body.

24. The roof as set forth in claim 16, wherein a sealing structure is provided at the outer end of the blade body; the sealing structure includes a sealing strip fixing portion and a matching portion connected to the outer end of the sealing strip fixing portion; the cross section of the mating portion is in the shape of a circular arc with a middle portion protruding to the outdoor side; the cross section of the sealing strip fixing portion is two limiting plates, and the two limiting plates extend outward from the outer end of the blade body, a sealing strip clamping groove is formed between the two limiting plates.

25. The roof as set forth in claim 16, wherein a baffle is provided on the outer surface of the blade body close to the swing shaft end, and the baffle extends toward the outer side of the blade body.

26. The roof as set forth in claim 16, wherein the blade body includes two blade plates, a transverse slot is formed between the two blade plates, a window communicating with the transverse slot is provided on the blade plate, and a transparent plate is inserted into the transverse slot.

27. The roof as set forth in claim 16, wherein a switch device is provided between at least one louver blade and the frame; the switch device includes a driving wheel and a driving rod; the driving wheel is fixed on the louver blade, the rotation center of the driving wheel is coaxial with the center of the pin accommodating hole, and the driving wheel is a worm gear; the driving rod passes through the frame, and the driving rod is a worm, which is engaged with the worm gear.

28. The roof as set forth in claim 16, wherein the linkage connection position is a hinge hole, a waist-shaped hole is provided on the linkage bar corresponding to the hinged hole, and a pin passes through the hinged hole and the waist-shaped hole.

29. A louver blade, comprising:
a blade body, wherein,
the blade body is provided with a swing shaft end and an outer swing end, the swing shaft end is located at one end of the blade body, the outer swing end is located at the other end of the blade body, a pin accommodating hole is provided at the swing shaft end, the outer swing end is provided with a protruding section protruding to the outer side of the wall, a linkage connection position is defined on the protruding section; a sealing structure is provided at the outer end of the blade body; the sealing structure includes a sealing strip fixing portion and a matching portion connected to the outer end of the sealing strip fixing portion; the cross section of the mating portion is in the shape of a circular arc with a middle portion protruding to the outdoor side; the cross section of the sealing strip fixing portion is two limiting plates, and the two limiting plates extend outward from the outer end of the blade body, a sealing strip clamping groove is formed between the two limiting plates, a sealing strip is defined in the sealing strip clamping groove.
